(19) United States
(12) Patent Application Publication
(10) Pub. No.: US 2008/0016081 A1
(43) Pub. Date: Jan. 17, 2008

(54) System and method for automatic digital library creation

(75) Inventors: David MacMillan, Emerald Hills, CA (US); Ted Theocheung, San Jose, CA (US); Mark Calomeni, San Jose, CA (US); Ray Robidoux, San Jose, CA (US); Charles Davis, San Jose, CA (US)

Correspondence Address: MORGAN, LEWIS & BOCKIUS, LLP., 2 PALO ALTO SQUARE, 3000 EL CAMINO REAL, PALO ALTO, CA, 94306, US

(73) Assignee: Anthology Solutions, Inc.

(21) Appl. No.: 11/486,716

(22) Filed: Jul. 14, 2006

(51) Int. Cl. G06F 17/30

(52) U.S. Cl. 707/10

(57) ABSTRACT

A system and method for automatic digital library creation is disclosed. One aspect of the invention involves a computer-implemented method in which a storage server in a LAN of a user: automatically receives content from a client device in the LAN, wherein: the received content is determined in accordance with a storage server profile for the storage server, and receiving content frees up storage space on the client device; stores at least some of the content received from the client device; automatically receives content via an external network that is complementary to the stored content received from the client device, wherein the complementary content is determined in accordance with the storage server profile; and stores the complementary content.

### RELATED APPLICATIONS

This application is related to U.S. patent application Ser. No. 11/337,199, filed Jan. 20, 2006, entitled “Compact, Integrated Storage and Networking Apparatus and Uses Thereof,” Attorney Docket 063250-5001-US, which application is incorporated by reference herein in its entirety.

This application is related to U.S. patent application Ser. No. ______ to be determined, filed Jul. 14, 2006, entitled “System and Method for Automatic Storage and Serving of Digital Content,” Attorney Docket 063250-5006-US, which application is incorporated by reference herein in its entirety.

### TECHNICAL FIELD

The disclosed embodiments relate generally to computer networks. More particularly, the disclosed embodiments relate to a system and method for automatic digital library creation in networks, such as home networks and other local area networks (LANs).

### BACKGROUND

With the advent of digital video recorders, video and still cameras, music players, and high-speed Internet access, the amount of digital content being used in homes and businesses has increased dramatically. As a result, the digital storage needs of homes and businesses are also expanding rapidly.

Individual digital devices quickly fill their on-board storage capacity. For example, digital video recorders, even with hundreds of gigabytes of storage space, typically hold less than a hundred hours of programming. Thus, digital video recorders must delete old programs to make room for the recording of new programs. If users want to keep old programs, they usually have to manually transfer and store the old programs elsewhere, e.g., onto a DVD. Similarly, desktop and laptop computers that are used to store and manipulate digital video and/or still images quickly use up their on-board storage.

For tech-savvy users, one way to increase storage capacity in the home or office is to create a LAN that includes a network attached storage (NAS) server. A storage server typically has a storage capacity that greatly exceeds the capacity of individual digital client devices. A user can connect individual client devices to the LAN or access the LAN via an external network and transfer video, image, audio, and/or other digital data from the client devices to the storage server. Storing content on the storage server frees up storage space on the client devices for reuse so that the client devices can continue to acquire content. Storing content on the storage server also allows other clients (local or remote) to share the content on the storage server.

To date, however, the process of transferring data to a storage server in a LAN is too cumbersome and complex. Most users do not have the time, desire, or technical proficiency to manage transferring content from their digital devices to a storage server. In addition, most users do not have the time, desire, or technical proficiency to manage retrieving content from the storage server so that it can be viewed on client devices in the LAN or on client devices in an external network that can connect to the NAS server. These problems are of particular concern for LANs in homes (i.e., home networks) and for LANs in small businesses, where IT professionals are not readily available to setup and manage the NAS server. Thus, there is a need to simplify the storage and serving of content in home networks and other LANs.

In addition, many home and business users want to create their own libraries of content. For example, some home users want to collect episodes of particular television shows and/or movies with a particular actor, director, or genre. These users may also want to collect complementary information about the television shows or movies, such as reviews, interviews, articles, and/or blogs about the movies or television programs (or about people and events associated with the movies or television programs). As another example, some users want to create their own music collections, along with complementary information about the musicians. Similarly, some users in business, government, and education want to create digital libraries with audio, video, and/or web content about particular topics in business, technology, or education.

To date, however, the process of creating a digital content library is also too cumbersome and complex. Users can record the television shows, movies, and other video content that interests them (e.g., using digital video recorders or personal computers), but then the users have to manually manage the transfer and long-term storage of this content (e.g., onto DVDs). In addition, the users must manually collect, transfer, and store the complementary content. Most users do not have the time, desire, or technical proficiency to manage creation and use of their own content libraries. Thus, there is a need to simplify the creation and use of content libraries.

### SUMMARY

The present invention reduces or eliminates the problems described above.

One aspect of the invention involves a computer-implemented method in which a storage server in a LAN of a user: automatically sends a request for content to a first client in the LAN, wherein the request for content is determined in accordance with one or more content transfer rules in a storage server profile for the storage server; in response to the request for content, receives content from the first client, wherein receiving content frees up storage space on the first client; stores at least some of the received content; automatically sends a request for content that is complementary to the stored received content to a computer in an external network, wherein the request for complementary content is determined in accordance with complementary content acquisition rules in the storage server profile; in response to the request for complementary content, receives complementary content from the computer in the external network; stores the complementary content; and serves at least some of the stored received content and at least a portion of the complementary content to a second client.

Another aspect of the invention involves a storage server in a LAN of a user. The storage server includes one or more processors, memory, and a program. The program is stored in the memory and configured to be executed by the one or more processors. The program includes: instructions for automatically sending a request for content to a first client in the LAN, wherein the request for content is determined in accordance with one or more content transfer rules in a storage server profile for the storage server; instructions for, in response to the request for content, receiving content from the first client, wherein receiving content frees up storage space on the first client; instructions for storing at least some of the received content; instructions for automatically sending a request for content that is complementary to the stored received content to a computer in an external network, wherein the request for complementary content is determined in accordance with complementary content acquisition rules in the storage server profile; instructions for, in response to the request for complementary content, receiving complementary content from the computer in the external network; instructions for storing the complementary content; and instructions for serving at least some of the stored received content and at least a portion of the complementary content to a second client.

Another aspect of the invention involves a computer-program product that includes a computer readable storage medium and a computer program mechanism embedded therein. The computer program mechanism includes instructions, which when executed by a storage server in a LAN of a user, cause the storage server to: automatically send a request for content to a first client in the LAN, wherein the request for content is determined in accordance with one or more content transfer rules in a storage server profile for the storage server; in response to the request for content, receive content from the first client, wherein receiving content frees up storage space on the first client; store at least some of the received content; automatically send a request for content that is complementary to the stored received content to a computer in an external network, wherein the request for complementary content is determined in accordance with complementary content acquisition rules in the storage server profile; in response to the request for complementary content, receive complementary content from the computer in the external network; store the complementary content; and serve at least some of the stored received content and at least a portion of the complementary content to a second client.

Another aspect of the invention involves a computer-implemented method in which a storage server in a LAN of a user: automatically receives content from a client device in the LAN, wherein: the received content is determined in accordance with a storage server profile for the storage server, and receiving content frees up storage space on the client device; stores at least some of the content received from the client device; automatically receives content via an external network that is complementary to the stored content received from the client device, wherein the complementary content is determined in accordance with the storage server profile; and stores the complementary content.

Another aspect of the invention involves a storage server in a LAN of a user. The storage server includes one or more processors, memory, and a program. The program is stored in the memory and configured to be executed by the one or more processors. The program includes: instructions for automatically receiving content from a client device in the LAN, wherein: the received content is determined in accordance with a storage server profile for the storage server, and receiving content frees up storage space on the client device; instructions for storing at least some of the content received from the client device; instructions for automatically receiving content via an external network that is complementary to the stored content received from the client device, wherein the complementary content is determined in accordance with the storage server profile; and instructions for storing the complementary content.

Another aspect of the invention involves a computer-program product that includes a computer readable storage medium and a computer program mechanism embedded therein. The computer program mechanism includes instructions, which when executed by a storage server in a LAN of a user, cause the storage server to: automatically receive content from a client device in the LAN, wherein: the received content is determined in accordance with a storage server profile for the storage server, and receiving content frees up storage space on the client device; store at least some of the content received from the client device; automatically receive content via an external network that is complementary to the stored content received from the client device, wherein the complementary content is determined in accordance with the storage server profile; and store the complementary content.

Another aspect of the invention involves a storage server in a LAN of a user, comprising: means for automatically receiving content from a client device in the LAN, wherein: the received content is determined in accordance with a storage server profile for the storage server, and receiving content frees up storage space on the client device; means for storing at least some of the content received from the client device; means for automatically receiving content via an external network that is complementary to the stored content received from the client device, wherein the complementary content is determined in accordance with the storage server profile; and means for storing the complementary content.

Thus, the invention greatly simplifies the creation and use of digital content libraries. Automatic (i.e., unattended) operation in accordance with a storage server profile greatly simplifies content library creation for users.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating an exemplary distributed computer system in accordance with embodiments of the present invention.

FIG. 2 is a block diagram illustrating a storage server in accordance with embodiments of the present invention.

FIG. 3A-3D are block diagrams illustrating exemplary storage system profiles in accordance with embodiments of the invention.

FIG. 4 is a block diagram illustrating an exemplary client in accordance with embodiments of the present invention.

FIG. 5 is a flowchart representing a method of configuring a storage server profile in accordance with embodiments of the present invention.

FIGS. 6A-6D are schematic screen shots of exemplary graphical user interfaces for configuring a storage server profile in accordance with embodiments of the present invention.

FIG. 7 is a flowchart representing a method of performing automatic storage and serving functions in accordance with embodiments of the present invention.

FIGS. 8A-8C are schematic screen shots of exemplary graphical user interfaces for selecting content in the storage server to be sent to a client device in accordance with embodiments of the present invention.

FIG. 9 is a flowchart representing a method of performing automatic storage and serving functions in accordance with embodiments of the present invention.

FIG. 10 is a flowchart representing a method of performing automatic storage and serving functions in accordance with embodiments of the present invention.

FIG. 11 is a flowchart representing a method of performing automatic library creation in accordance with embodiments of the present invention.

FIG. 12 is a flowchart representing a method of performing automatic library creation in accordance with embodiments of the present invention.

### DESCRIPTION OF EMBODIMENTS

A system and method for automatic digital library creation are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

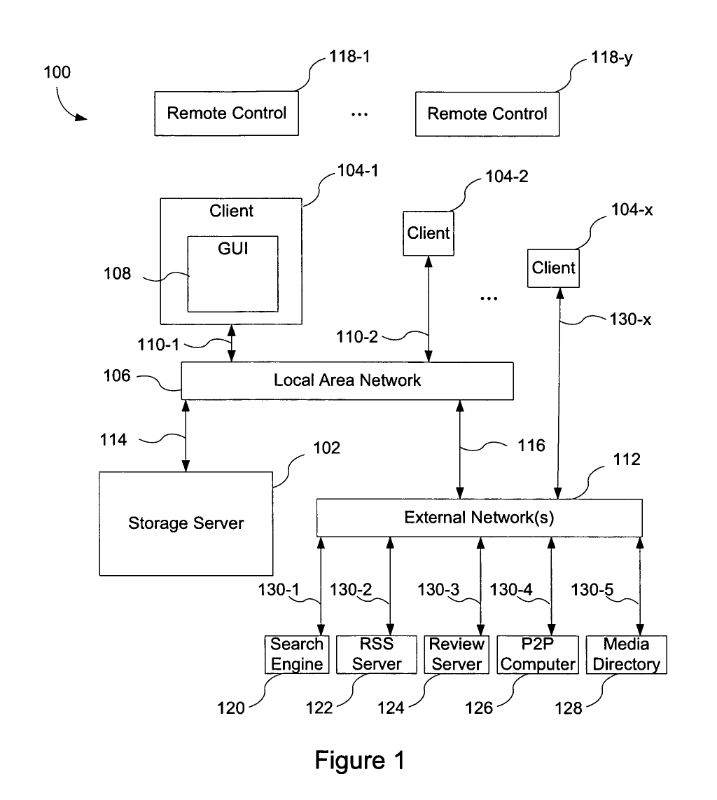

FIG. 1 is a block diagram illustrating an exemplary distributed computer system 100 in accordance with embodiments of the invention. FIG. 1 shows various functional components that will be referred to in the detailed discussion that follows. This system includes client devices 104, storage server 102, and LAN 106 for interconnecting these components. LAN 106 (e.g., a home network) may also be connected to external network(s) 112, such as the Internet. Network connections 110, 114, and 116 to LAN 106 and network connections 130 to external network 112 can be either wireline or wireless connections.

Client devices 104 can be any of a number of digital electronic devices (e.g., a digital video recorder, digital media adapter, digital video camera, digital still camera, digital music player, Internet radio, personal digital assistant, cell phone, gaming console, handheld gaming device, desktop computer, laptop computer, handheld computer, or a combination thereof) used to enable the activities described below. Some clients 104 may have a display with a graphical user interface (GUI) 108. Some clients may only be used for recording content (e.g., a security camera); some clients may only be used for playing content (e.g., a digital media adapter); and some clients may be used for both recording and playing content (e.g., a digital video recorder). In the following description, when a client is used to record content, a record-capable client is assumed and, when a client is used to play content, a play-capable client is assumed.

Some clients 104 may have their own remote controls 118 for managing the content that is acquired, stored, displayed, and/or transferred on the corresponding client. The use of a remote control 118 typically provides a simpler user interface that more users are comfortable with. The remote control creates a television-viewing-like interface that is familiar to users, rather than a personal-computer-like interface that may confuse or intimidate some users. In some embodiments, one remote control 118 is used to manage multiple clients 104 in LAN 106. In some embodiments, one remote control 118 is used to manage all of the clients 104 in LAN 106.

The external network 112 may include:
search engine 120 that may send search results that relate to content in LAN 106 to storage server 102 or a client 104;
RSS server 122 that may send RSS feeds (or portions thereof) that relate to content in LAN 106 to storage server 102 or a client 104;
content review/ratings server 124 that may send reviews and/or ratings of content in LAN 106 to storage server 102 or a client 104;
peer-to-peer computer(s) 126 (e.g., computers with BitTorrent clients) that may send content to storage server 102 or a client 104; and
media directory or guide 128 (e.g., You Tube, Yahoo! TV, Google Video, or Live365) that provides programming information that may be used by storage server 102 to control the content that is acquired by some client devices (e.g., television programs for a digital video recorder or radio programs for an Internet radio).

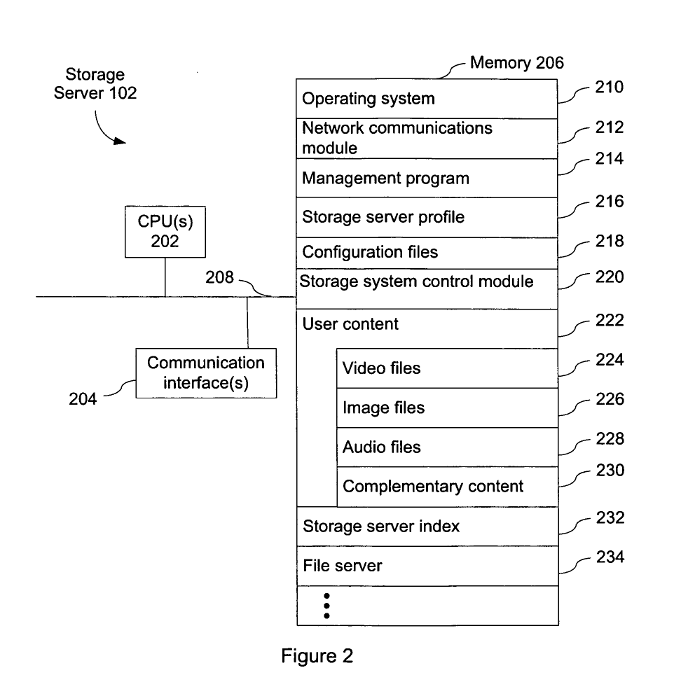

FIG. 2 is a block diagram illustrating storage server 102 in accordance with embodiments of the present invention. Storage server 102 typically includes one or more processing units (CPUs) 202, one or more network or other communications interfaces 204, memory 206, and one or more communication buses 208 for interconnecting these components. The communication buses 208 may include circuitry (sometimes called a chipset) that interconnects and controls communications between system components. Storage server 102 may optionally include a graphical user interface (not shown), which typically includes a display device, a keyboard, and a mouse or other pointing device. Memory 206 may include high-speed random access memory and may also include non-volatile memory, such as one or more magnetic or optical storage disks and/or flash memory. Memory 206 may store the following programs, modules and data structures, or a subset or superset thereof:
operating system 210 that includes procedures for handling various basic system services and for performing hardware dependent tasks;
network communications module (or instructions) 212 that is used for connecting storage server 102 to other computers (e.g., clients 104) via the one or more communications network interfaces 204 (wired or wireless) and LAN 106 (FIG. 1) and to external network(s) 112, such as the Internet, wide area networks, other local area networks, metropolitan area networks, and so on;
integrated management program 214 that configures and manages storage (e.g., in accordance with profile 216) and serving functions (e.g., using input received from a menu-based GUI 108 and a remote control 118 or a browser-based GUI 108);
storage server profile 216 that includes rules specifying content to be transferred and stored in storage server 102 from one or more client devices 104 associated with the user, which may be configured by the user or automatically configured without user intervention (e.g., by automatically transferring copies of the content in clients 104 connected to LAN 106 or by monitoring and drawing inferences from the user's actions with client devices 104);
configuration files 218 that are produced and/or revised by management program 214;
storage system control module 220 that manages secure storage of user content (e.g., with capabilities for RAID 0, RAID 1, RAID 1+0, RAID 5 and/or other redundant storage techniques using multiple storage devices; and/or with disk scrubbing that automatically finds and repairs inconsistencies in the stored content and its computed parity in the storage devices);
user content 222 that includes files transferred from client devices 104 (e.g., video files 224, image files 226, audio files 228, and/or other data) and complementary content 230 (e.g., video, image, audio, text, and/or other data files received from an external network 112 that complement the files transferred from client devices 104);
storage server index 232 that includes a list of the content 222 stored in memory 206;
file server 234 that serves content 222 to clients 104 (e.g., by streaming content 222 to a client 104 and/or by sending content 222 to a client 104 for download and storage on the client).

As used in the specification and claims, a “storage server profile” (e.g., storage server profile 216) is a data structure that includes transfer/storage rules specifying content from one or more client devices associated with a user to be transferred to and stored in a storage server. As explained below, the storage server profile enables automatic transfer and storage of content from the user's client devices to a storage server. Unattended transfer and storage of content greatly simplifies storage management for the user and frees up storage space on the client devices for reuse. As used herein, a “user” may be an individual or a group of people (e.g., a family in a home setting or workers in a business setting). The client device may be associated with the user in a variety of ways, such as by being in the user's LAN 106 or by having its client ID 302 included in the server storage profile 216 based on input by the user.

In some embodiments, the transfer/storage rules specify particular content or types of content to be transferred and then all of the transferred content is stored in the storage server (i.e., the transfer/storage rules filter client content prior to transfer). In other embodiments, for a given client device, all of its content is transferred to the storage server, the rules are used to filter the received content, and just the content that remains after filtering is stored in the storage server (i.e., the transfer/storage rules filter client content after transfer). In still other embodiments, the transfer/storage rules specify particular content or types of content to be transferred (e.g., only content that has not been previously transferred or content created in a specified time period), the rules are also used to filter the received content, and just the content that remains after filtering is stored in the storage server (i.e., the transfer/storage rules filter client content both before and after transfer). The content that is filtered out at the storage server may nevertheless be temporarily stored on the storage server (e.g. prior to filtering).

In some embodiments, the storage server profile 216 also includes rules for acquiring complementary content (e.g., video, image, audio, text, and/or other data files that complement the content transferred from client devices 104) from an external network (e.g., the Internet). As explained below, in these embodiments, the storage server profile enables automatic transfer and storage of content from client devices associated with the user and complementary content from devices (e.g., servers and/or peer computers) in an external network. Unattended collection of such content greatly simplifies the creation of tailored content libraries.

In some embodiments, the storage server profile 216 also includes rules for displaying information about content stored on the storage server and/or accessing content stored on the storage server. These rules can be used to provide parental controls, thereby preventing children from seeing information about mature content and/or accessing such content. These rules can also be used to limit the amount of information about content displayed to a particular user (e.g., limiting the displayed information to content consistent with a profile for the user within the storage server profile). Thus, these rules can help the user find content on the storage server that he or she is interested in viewing faster by reducing the amount of irrelevant information displayed to the user.

In some embodiments, the storage server profile 216 also includes rules for one or more clients associated with the user to acquire content. Some of this acquired content may be subsequently transferred to and stored on the storage server in accordance with the transfer/storage rules. Client content acquisition rules may be used to avoid recording the same content on multiple clients and to arbitrate which clients are used to record which content when two different shows occur at the same time.

In some embodiments, the storage server profile 216 also includes rules for backing up data on clients to the storage server. Each piece of backed up data primarily resides on and is used by a particular client, so backing up this data does not free up or otherwise make available the storage space occupied by this data on the client. In contrast, the storage space occupied by content that is transferred to and stored on the storage server in accordance with the transfer/storage rules is freed up for reuse by the client.

In some embodiments, the total capacity of the storage devices used to store user content 222 is one terabyte or more. In some embodiments, the capacity can be expanded by connecting more storage devices (e.g., magnetic or optical disk drives) to storage server 102.

Each of the above identified modules and applications in FIG. 2 includes a set of instructions for performing a function described above. These modules (i.e., sets of instructions) need not be implemented as separate software programs, procedures or modules, and thus various subsets of these modules may be combined or otherwise rearranged in various embodiments. In some embodiments, memory 206 may store a subset of the modules and data structures identified above. Furthermore, memory 206 may store additional modules and data structures not described above.

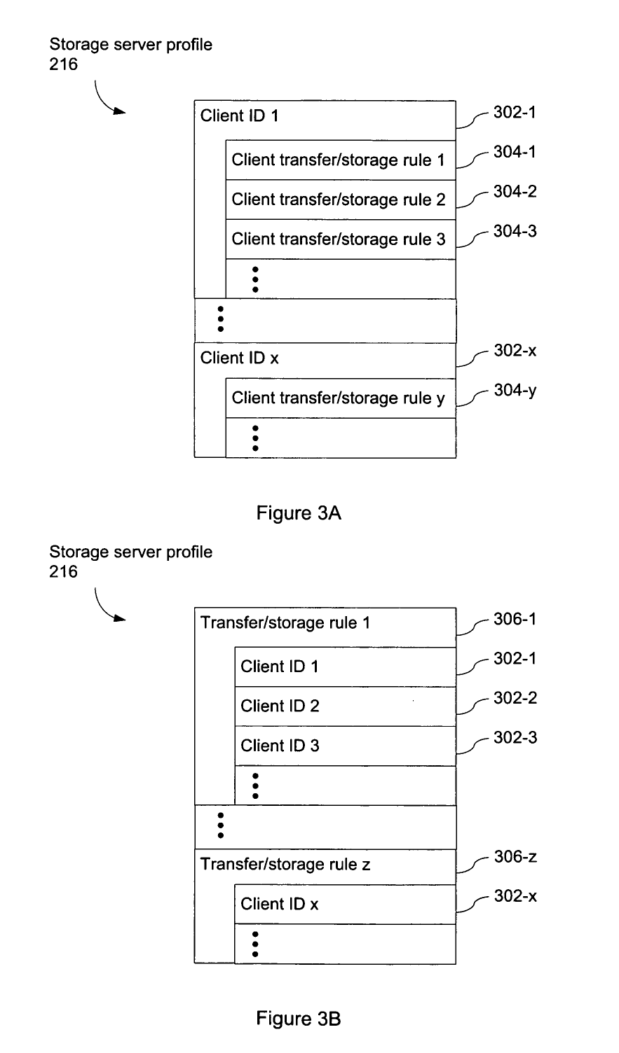

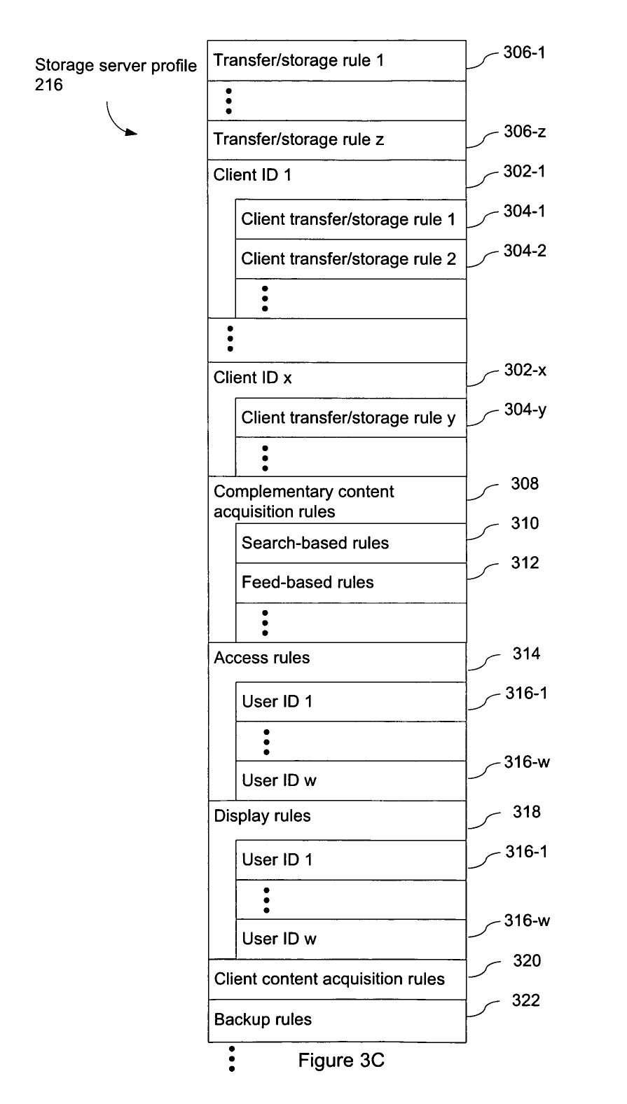

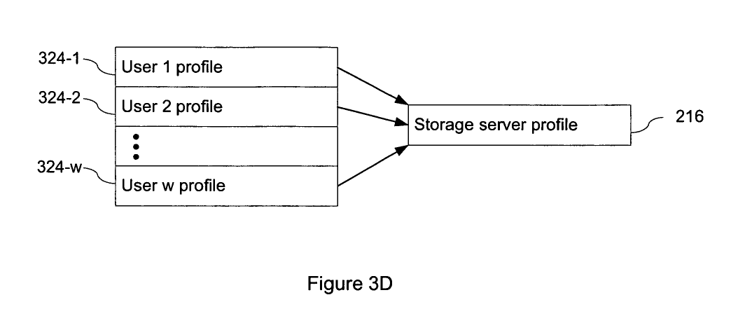

FIGS. 3A-3D are block diagrams illustrating exemplary storage system profiles 216 in accordance with embodiments of the invention. Storage server profile 216 may include the following data, or a subset or superset thereof:
client identifiers 302 (e.g., Ethernet addresses, IP addresses, NetBIOS names, or fully qualified domain names) that uniquely identify each client 104 associated with the user;
content transfer/storage rules 304 and 306 that specify conditions for sending client content 416 to storage server 102 (e.g., what content to send and when to send it) and/or conditions for storing content received by the storage server;
complementary content acquisition rules 308 that specify conditions for transferring external content on external networks 112 (e.g., the Internet) that relates to video files 224, image files 226, audio files 228, and/or other data (e.g., text files) in user content 222 to storage server 102, which may include:
   search-based rules 310 (e.g., transfer the top N web sites or web pages from a web search based on the title, actors, or director of a television program or movie in user content 222, where N is an integer) and
   feed-based rules 312 (e.g., transfer content offered in an RSS feed or portion thereof that relates to a television program, movie, or Internet radio program in user content 222);
access rules 314 that limit the content 222 that may be seen and/or heard by particular users with user identifiers 316;
display rules 318 that limit the information about content 222 (e.g., titles, promotional images, plot summaries and other programming information) that may be seen and/or heard. In some embodiments, the display of information is restricted for particular users with user identifiers 316. In some embodiments, the display of information is restricted, unless the user enters a pass code, for content: with a particular maturity rating, on a particular channel, or with a particular title;
client content acquisition rules 320 that specify the content to be acquired by one or more clients 104 associated with the user. Some of this acquired content may be subsequently transferred to and stored on storage server 102 in accordance with transfer/storage rules 304 and/or 306; and
backup rules 322 that specify data on clients 104 associated with the user that are to be backed up onto storage server 102. Each piece of backed up data primarily resides on and is used by a particular client, so backing up this data does not free up or otherwise make available the storage space occupied by this data on the client. In contrast, the storage space occupied by content that is transferred to and stored on storage server 102 in accordance with transfer/storage rules 304 and/or 306 is made available for reuse by the client 104.

Storage system profile 216 may be a table in a database with rules and corresponding clients.

In FIG. 3A, the storage system profile 216 includes a list of client IDs 302 for clients 104 in LAN 106 and other clients associated with the user and client transfer/storage rules 304 that are specific to each corresponding client.

In FIG. 3B, the storage system profile 216 includes transfer/storage rules 306 that apply to one or more clients, e.g., global transfer/storage rules for particular types of clients 104 (e.g., a rule that transfers all content from all digital video recorders in LAN 106).

In FIG. 3C, the storage system profile 216 includes a mix of transfer/storage rules 306 (e.g., global transfer/storage rules) and client transfer/storage rules 304. In addition, the storage system profile 216 includes complementary content acquisition rules 308 with search-based rules 310 and feed-based rules 312; access rules 314 for users 316; display rules 318 for users 316; client content acquisition rules 320; and backup rules 322. In some embodiments, the display rules 318 and/or access rules 314 can use a pass code (e.g., a 4-digit PIN) rather than user identifiers 316 to limit display and/or access to content in LAN 106 and/or in server 102.

FIG. 3D is a schematic illustrating that the storage system profile 216 may be derived from individual users profiles 324 analogous to the profiles shown in FIGS. 3A-3C. For example, individual users may enter preferences for content transfer and storage from client devices 104 and preferences for complementary content that are merged together into a single, overall system profile 216, subject to display and/or access rules specified by a particular user (e.g., a parent or administrator). The merged profile 216 may be used by management program 214 to optimize the use of storage devices in memory 206 (e.g., by not transferring or storing additional copies of content that is already stored in user content 222 and/or by storing different copies of the same content that are optimized for playback in different clients (e.g., handheld devices versus big-screen devices).

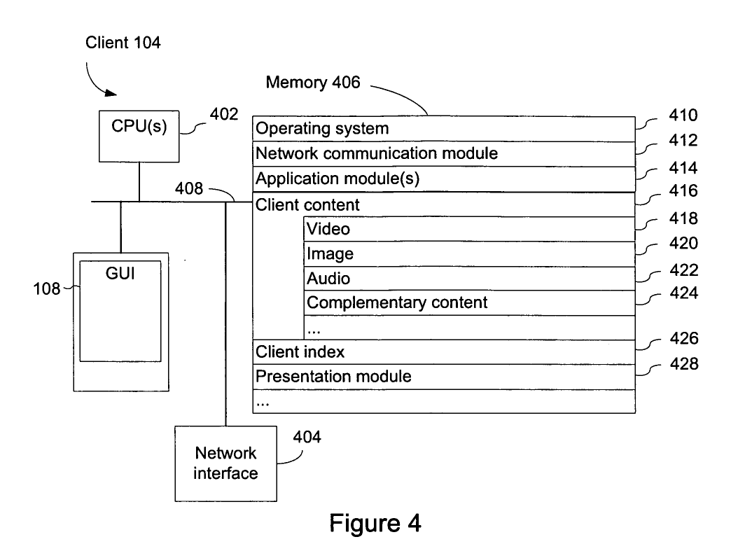

FIG. 4 is a block diagram illustrating an exemplary client 104 in accordance with embodiments of the present invention. As noted above, client 104 may include graphical user interface (GUI) 108. Client 104 typically includes one or more processing units (CPUs) 402, one or more network or other communications interfaces 404, memory 406, and one or more communication buses 408 for interconnecting these components. The communication buses 408 may include circuitry (sometimes called a chipset) that interconnects and controls communications between system components. Memory 406 may include high-speed random access memory and may also include non-volatile memory, such as one or more magnetic or optical storage disks and/or flash memory. Client memory 406 may store the following programs, modules and data structures, or a subset or superset thereof:
operating system 410 that includes procedures for handling various basic system services and for performing hardware dependent tasks;
network communication module (or instructions) 412 that is used for connecting client 104 to other computers (e.g., storage server 102) via the one or more communications network interfaces 404 (wired or wireless) and LAN 106 (FIG. 1) and to external network(s) 112, such as the Internet, wide area networks, other local area networks, metropolitan area networks, and so on;
application module(s) 414 for creating, receiving, and/or storing content 416 on client 104;
client content 416 that may include digital video 418, image 420, audio 422, and/or other data files and complementary content 424 (e.g., content corresponding to portions of complementary content 230 served to client 104 by server 102);
client index 426 that includes a list of the client content 416 stored in client memory 406; and
presentation module 428 for displaying client content 416.

Because the content 416 on client 104 can be automatically transferred to and stored on storage server 102, as well as quickly and easily transferred back to client 104 from storage server 102, the amount of on-board memory 406 (e.g., disk drives and other non-volatile storage in the client) needed to store client content 416 can be reduced. In some embodiments, digital video recorder clients just contain enough storage space to hold a few television programs at the image resolution desired by the user (e.g., high-quality or high definition). For these digital video recorders, most of the video content 418 in the digital video recorder is automatically off-loaded and stored in the storage server 102. In some embodiments, a diskless digital video recorder automatically transfers and stores video content in storage server 102 and plays back video content that is streamed from the storage server 102.

Each of the above identified modules and applications in FIG. 4 includes a set of instructions for performing a function described above. These modules (i.e., sets of instructions) need not be implemented as separate software programs, procedures or modules, and thus various subsets of these modules may be combined or otherwise re-arranged in various embodiments. In some embodiments, memory 406 may store a subset of the modules and data structures identified above. Furthermore, memory 406 may store additional modules and data structures not described above.

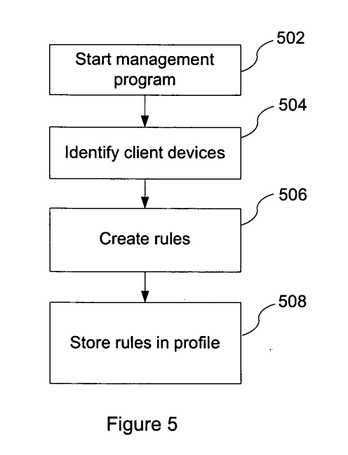

FIG. 5 is a flowchart representing a method of configuring a storage server profile 216 in accordance with embodiments of the present invention. The processes shown in FIG. 5 (or subsets or supersets thereof) are performed by storage server 102 in LAN 106 (FIG. 1). It will be appreciated by those of ordinary skill in the art that one or more of the acts described may be performed by hardware, software, or a combination thereof. In addition, it will be appreciated by those of ordinary skill in the art that some of the processes shown in FIG. 5 (or subsets or supersets thereof) can be performed in a different order.

Storage server 102 starts (502) management program 214. Management program 214 identifies (504) client devices 104 associated with the user. In some embodiments, client devices in LAN 106 are identified by their unique client IDs 302 using Universal Plug and Play (UPnP) technology.

Management program 214 creates (506) client transfer/storage rules 304 and/or transfer/storage rules 306 that apply to multiple clients. In some embodiments, management program 214 also creates complementary content acquisition rules 308, access rules 314, display rules 318, client content acquisition rules 320, and/or backup rules 322. In some embodiments, the rules are based on input received from a user (e.g., in response to user selections with a remote control 118 or via user selections with a web browser at a client 104). If the storage server 102 has no display, then the input received from the user may be via a client 104 with a GUI 108.

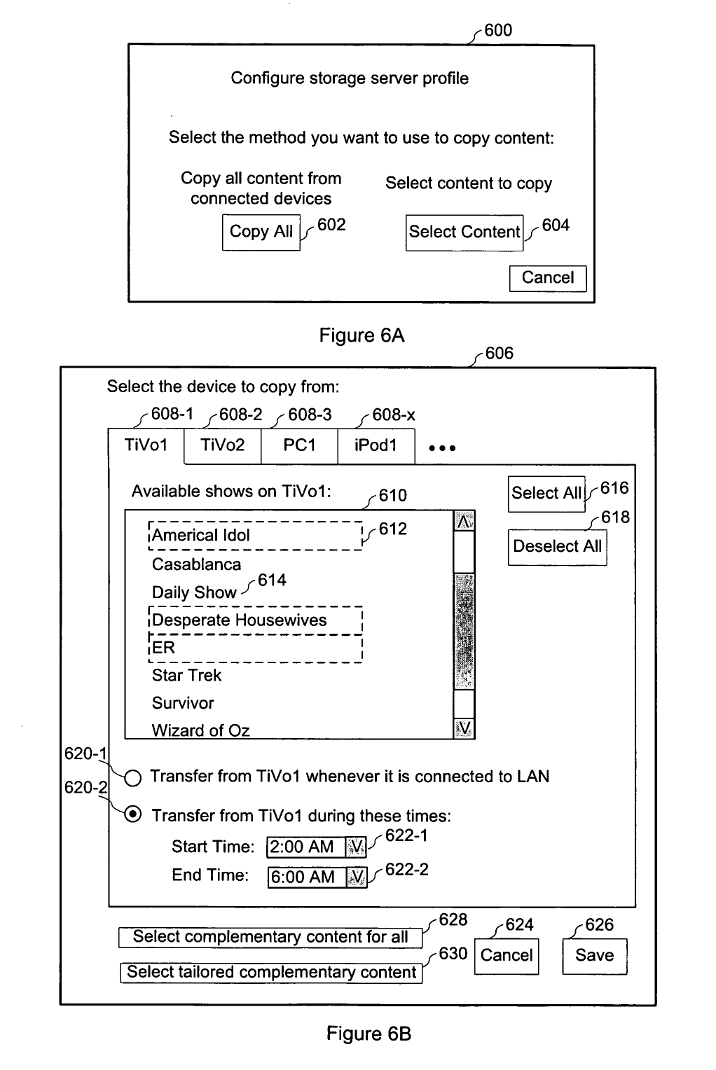

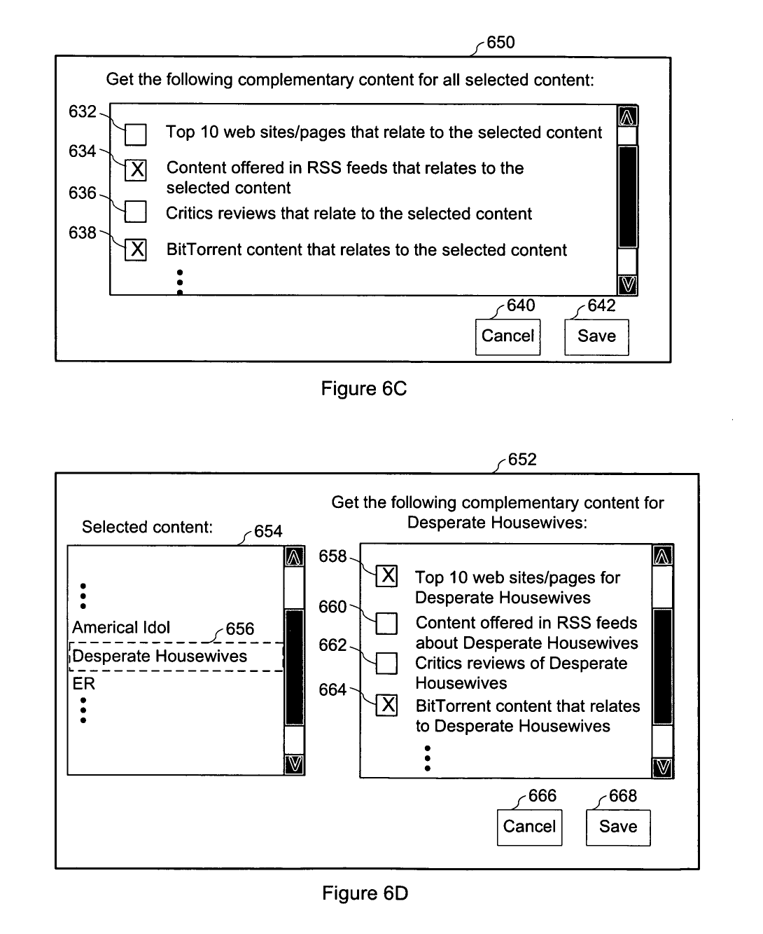

FIGS. 6A-6D are schematic screen shots of exemplary graphical user interfaces for configuring a storage server profile 216 in accordance with embodiments of the present invention. In some embodiments, GUI 600 (FIG. 6A) includes the following elements, or a subset or superset thereof:
Copy All icon 602 that initiates creation of transfer/storage rules 306 in storage server profile 216 that transfer all content from clients 104 associated with the user that are connected to LAN 106 (either directly or via an external network 112); and
Select Content icon 604 that initiates creation of transfer/storage rules 304 and/or 306 and complementary content acquisition rules 308 that may be easily tailored by a user (e.g., by client 104, by type of client device, by content file, by type of content, and/or by transfer time) using GUIs such as that shown in FIG. 6B.

In some embodiments, GUI 606 (FIG. 6B) includes the following elements, or a subset or superset thereof:
Client icons 608 that are used to select a particular client 104 associated with the user, such as a client 104 in LAN 106 or other client listed in storage server profile 216;
A list 610 of content and/or content types on a particular client (e.g., the client chosen with client icon 608) that may be selected for automatic transfer and storage on server 102 (e.g., transferring highlighted/selected 612 shows or series such as American Idol, Desperate Housewives, and ER, but not transferring unhighlighted/unselected 614 shows or series such as Casablanca, Daily Show, Star Trek, Survivor, and the Wizard of Oz);
Select All icon 616 that selects all content on a particular client (e.g., the client chosen with client icon 608) for automatic transfer and storage on server 102;
Deselect All icon 618 that deselects all content in list 610;
Transfer time icons 620 that select transfer scheduling rules for the selected content in a particular client (or, alternatively, for all clients (not shown)) such as icon 610-1 for transferring content from the client whenever the client is connected to the LAN 106 (either directly or via an external network 112) and icon 610-2 for transferring content from the client during user-specified times 622;
Cancel icon 624 for canceling the creation of user-selected transfer/storage rules or for canceling changes in the existing user-selected transfer/storage rules;
Save icon 626 for initiating the creation and/or storage of transfer/storage rules 304 corresponding to the user selections in GUI 606;
Select Complementary Content For All icon 628 that initiates creation of complementary content acquisition rules 308 for all selected content that may be easily tailored by a user using GUIs such as that shown in FIG. 6C; and
Select Tailored Complementary Content icon 630 that initiates creation of complementary content acquisition rules 308 for each piece of selected content (or type of content, not shown in FIG. 6) that may be easily tailored by a user using GUIs such as that shown in FIG. 6D.

In some embodiments, GUI 650 (FIG. 6C) includes the following elements, or a subset or superset thereof:
Complementary content selection icons that select complementary content acquisition rules for all selected content, such as:
   icon 632 for getting and storing the top 10 web sites or web pages (e.g., search results obtained via Google, Yahoo! or other search engine 120) that relate to the selected content;
   icon 634 for getting and storing content offered in RSS feeds (e.g., from RSS server 122) that relate to the selected content;
   icon 636 for getting and storing critics reviews (e.g., from review/ratings server 124) that relate to the selected content; and
   icon 638 for getting and storing BitTorrent content (e.g., from peer-to-peer computer 126) that relates to the selected content;
Cancel icon 640 for canceling the creation of global complementary content acquisition rules or for canceling changes in the existing global complementary content acquisition rules; and
Save icon 642 for initiating the creation and/or storage of global complementary content acquisition rules 308 corresponding to the user selections in GUI 650.

In some embodiments, GUI 652 (FIG. 6D) includes the following elements, or a subset or superset thereof:
A list 654 of selected content and/or types of selected content;
Complementary content selection icons that select complementary content acquisition rules for each piece or type of selected content (e.g., Desperate Housewives 656), such as:
   icon 658 for getting and storing the top 10 web sites or web pages (e.g., search results obtained via Google, Yahoo! or other search engine 120) that relate to a particular piece or type of selected content;
   icon 660 for getting and storing content offered in RSS feeds (e.g., from RSS server 122) that relate to a particular piece or type of selected content;
   icon 662 for getting and storing critics reviews (e.g., from review/ratings server 124) that relate to a particular piece or type of selected content; and
   icon 664 for getting and storing BitTorrent content (e.g., from peer-to-peer computer 126) that relates to a particular piece or type of selected content;
Cancel icon 666 for canceling the creation of complementary content acquisition rules or for canceling changes in the existing complementary content acquisition rules; and
Save icon 668 for initiating the creation and/or storage of complementary content acquisition rules 308 corresponding to the user selections in GUI 652.

Similar configuration GUIs (not shown) can be used to create and store display rules 318, accesss rules 314, client content acquisition rules 320, and backup rules 322 in the storage server profile 216. These additional configuration GUIs are known in the art and need not be described in detail.

A user may easily configure a storage server profile 216 by simply making selections (e.g., with a remote control 118 or web browser) from GUIs such as those shown in FIGS. 6A-6D. The server profile configuration GUIs may be viewed on client devices with displays or on storage server 102 if it includes a display. Configuring a storage server profile 216 with input via a remote control 118 is particularly simple for most users because it provides a familiar television-viewing-like experience.

In some embodiments, the transfer/storage rules are created without explicit user input. For example, a default profile 216 (analogous to selection of Copy All icon 602) may automatically transfer copies of the content in all clients 104 associated with the user that are connected to LAN 106.

Management program 214 stores (508) the client identifiers 302 and transfer/storage rules 304 and/or 306 in profile 216. In some embodiments, rules 308, 314, 318, 320 and/or 322 are also stored in profile 216. As new clients 104 are associated with the user (e.g., by adding the new client to LAN 106), management program 214 may automatically prompt the user to provide input that can be used to create transfer/storage rules 304 and/or 306 and complementary content acquisition rules 308 for the newly added client. Alternatively, the stored rules may be set to apply to whatever clients are connected to the LAN when the rules are executed (i.e., rules are stored (508) in the profile 216 before clients are identified (504)).

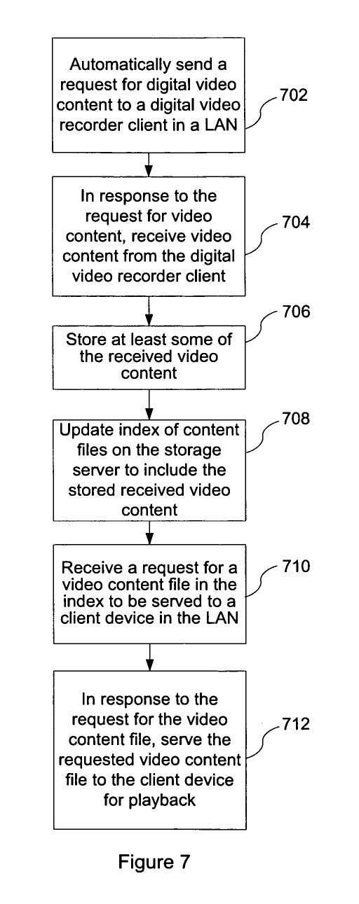

FIG. 7 is a flowchart representing a method of performing automatic storage and serving functions in accordance with embodiments of the present invention. The processes shown in FIG. 7 (or subsets or supersets thereof) are performed by storage server 102 in LAN 106 (FIG. 1). It will be appreciated by those of ordinary skill in the art that one or more of the acts described may be performed by hardware, software, or a combination thereof. In addition, it will be appreciated by those of ordinary skill in the art that some of the processes shown in FIG. 7 (or subsets or supersets thereof) can be performed in a different order.

Management program 214 automatically sends (702) a request for digital video content to a digital video recorder client 104 in LAN 106. The request for content is determined in accordance with storage server profile 216 for storage server 102. In some embodiments, the storage server profile 216 is configured by the user with remote control 118. In some embodiments, the digital video content is encrypted. In some embodiments, LAN 106 is a home network.

In some embodiments, the storage server profile 216 includes rules 304 and/or 306 specifying content 416 from one or more client devices 104 to be transferred and stored in the storage server 102. In some embodiments, the rules include global rules (e.g., transfer and store all video content from all digital video recorders or transfer and store all video content from all digital video recorders that includes a particular actor, director, genre, reviewer(s) rating and/or maturity rating), client-specific rules (e.g., transfer and store from digital video recorder x content that satisfies condition y), and/or transfer scheduling rules. In some embodiments, video content 418 has metadata (e.g., metatags) that include the actors, director, genre, reviewer(s) ratings and/or maturity ratings for the content or has an associated file of program information that includes such metadata. The metadata may be used to select video content 418 for transfer and storage.

In some embodiments, programs marked in the digital video recorder GUI 108 for long-term storage on the digital video recorder automatically have a corresponding transfer/storage rule created that will transfer and store the marked programs onto the storage server 102, thereby freeing up storage on the digital video recorder for reuse.

In some embodiments, the storage server profile 216 is configured by the user. In some embodiments, the storage server profile is automatically configured without user intervention.

In some embodiments, the digital video recorder is a TiVo digital video recorder. As described in U.S. Patent Application Publication 2005/0108519 A1 (entitled “Secure Multimedia Transfer System”), which is incorporated by reference herein in its entirety, the contents of the digital video recorder may be encrypted to ensure that the content is only used on authorized client devices. In some embodiments, the digital video recorder is a Windows Media Center-compatible digital video recorder.

In response to the request for digital video content, storage server 102 receives (704) digital video content from the digital video recorder client 104 (e.g., via LAN 106). Receiving the digital video content frees up storage space on the digital video recorder client 104.

In some embodiments, at least some video content 418 in the digital video recorder client 104 is acquired by the digital video recorder client 104 in accordance with client content acquisition rules 320 in the storage server profile 216. In these embodiments, in addition to managing the transfer and storage of content from client devices 104, storage server 102 also manages the initial acquisition of content on at least one of the digital video recorder clients 104 (e.g., using content acquisition techniques analogous to those described in U.S. Pat. Nos. 6,642,939 and 6,757,906 and U.S. patent application Ser. Nos. 10/339,699 and 10/034,679, which are all incorporated by reference herein in their entirety). In some embodiments, client content acquisition rules 320 may use data from a web site in the external network 112 to determine the content that is acquired (e.g., getting the top-rated movies listed in the Internet Movie Database (www.imdb.com), getting movies of a particular genre above a particular rating in the Internet Movie Database, or getting audio or video content recommended by media directory 128 or other content guide web site).

Storage server 102 stores (706) at least some of the received digital video content (e.g., in video files 224). In some embodiments, the stored received digital video content is selected from the received digital video content in accordance with the storage server profile 216. In some embodiments, the freed up storage space on the digital video recorder corresponds to the digital video content that is received and stored on the storage server. In some embodiments, content on the client 104 that corresponds to the content stored by storage server 102 is marked as available for deletion, deleted, or otherwise made available for reuse to free up storage space on the client 104. In some embodiments, the stored received digital video content is stored in a RAID 5 array of storage devices. In some embodiments, in a process known as “disk scrubbing,” the storage devices are automatically reviewed for consistency, and inconsistencies in the stored content and its computed parity are found and repaired.

Management program 214 updates (708) the index 232 of content files on the storage server to include the stored received digital video content. In some embodiments, the index 232 is a hierarchical data structure. In some embodiments, the user is notified that new content has been added to storage server 102, e.g., by displaying a message in a GUI 108 on a client 104 and/or by sending an e-mail, text message, or other electronic message to the user.

Management program 214 receives (710) a request for a video content file 224 in the index 232 to be served to a client device 104 in the LAN 106. In some embodiments, the request for the video content file is made in response to the user selecting a menu item with a remote control 118. In some embodiments, the client device 104 is authorized to receive and/or play the video content file.

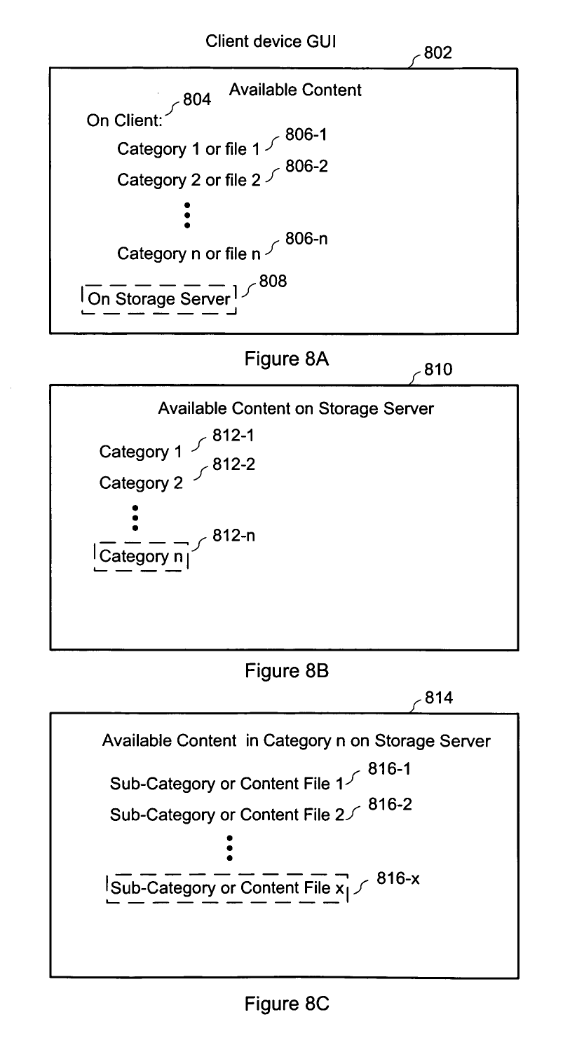

FIGS. 8A-8C are schematic screen shots of exemplary graphical user interfaces for selecting content 222 in the storage server 102 to be sent to a client device 104 in accordance with embodiments of the present invention. In some embodiments, GUI 802 (FIG. 8A) includes the following elements, or a subset or superset thereof:
A display of content 416/804 (or portion thereof) stored on a particular client 104 (e.g., a client 104 that may also request content 222 from the storage server 102 with a remote control 118), which may include a list of content categories (e.g., video, music, photos, and/or sub-categories thereof) and/or content files 806. User selection of a category may bring up a new GUI (not shown) displaying the sub-categories and/or files in the chosen category. User selection of a content file may initiate playing the file or may bring up a new GUI displaying additional information about the chosen file (e.g., promotional information about the content) and an option to initiate playing the file; and
An icon 808 that when selected displays a new GUI with available content on the storage server (e.g., GUI 810, FIG. 8B).

In some embodiments, GUI 802 may display a list of available content (or portions thereof) or a list of content categories without identifying whether the content is on the client 804 or on the storage server 808. In other words, the storage location of the available content is transparent to the user.

In some embodiments, the display of available content may be limited by display rules 316 for certain users (e.g., children or those who have not entered a pass code).

In some embodiments, GUI 810 (FIG. 8B) includes the following elements, or a subset or superset thereof:
A display of available content 222 (or portion thereof) on storage server 102, which may include a list of content categories (e.g., video, music, photos, and/or sub-categories thereof) 812 on storage server 102. User selection of a category (e.g., highlighted category 812-n) may bring up a new GUI (e.g., GUI 814, FIG. 8C) displaying sub-categories and/or files 816 in the chosen category.

In some embodiments, GUI 814 (FIG. 8C) includes the following elements, or a subset or superset thereof:
A display of sub-categories and/or files 816 in the chosen category. User selection of a sub-category may bring up a new GUI (not shown) displaying further sub-categories and/or files in the chosen sub-category. User selection of a content file may initiate serving of the file by storage server 102 and playing of the file on a client 104 (e.g., the client that GUI 814 is being displayed on or another client selected by the user with remote control 118) or may bring up a new GUI displaying additional information about the chosen file (e.g., promotional information about the content) and an option to initiate serving and playing the file (e.g., by pressing a button on the remote control 118) on a client 104 (e.g., the client that GUI 814 is being displayed on or another client selected by the user with remote control 118).

GUIs like those shown in FIGS. 8A-8C may be incorporated into client interface GUIs for acquiring and selecting content such as those described in U.S. Pat. No. 6,642,939, U.S. Pat. No. 6,757,906, and U.S. patent application Ser. No. 10/029,771, which are all incorporated by reference herein in their entirety. There are many ways for the GUIs to categorize and display available content, including, without limitation, by show, station, searchable description, air date, genre, actor, director, reviewer(s) rating (e.g., 5 stars), maturity rating, and/or language.

In response to the request for the video content file, file server 234 serves (712) the requested video content file 224 to the client device 104 for playback. In some embodiments, the client device 104 is a digital video recorder. In some embodiments, the client device 104 is a desktop computer, laptop computer, handheld computer, personal digital assistant, handheld video player, gaming console, handheld gaming device, cell phone, or a combination thereof. In some embodiments, serving includes streaming the requested video content file 224 to the client device 104. In some embodiments, serving includes sending the requested video content file 224 to the client device 104 for download and storage.

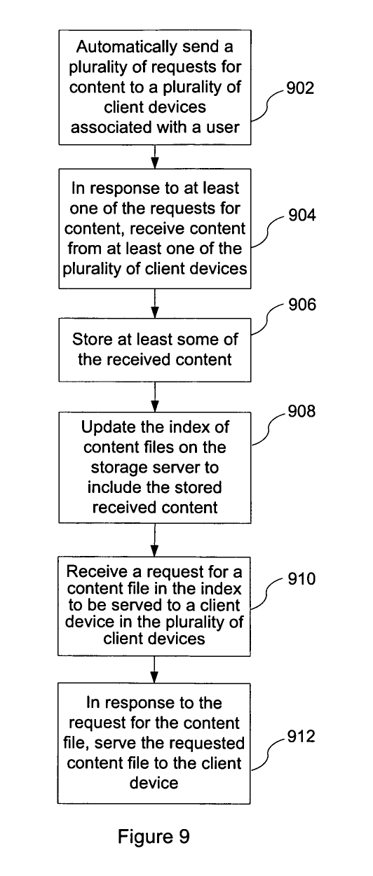

FIG. 9 is a flowchart representing a method of performing automatic storage and serving functions in accordance with embodiments of the present invention. The processes shown in FIG. 9 (or subsets or supersets thereof) are performed by storage server 102 (FIG. 1). It will be appreciated by those of ordinary skill in the art that one or more of the acts described may be performed by hardware, software, or a combination thereof. In addition, it will be appreciated by those of ordinary skill in the art that some of the processes shown in FIG. 9 (or subsets or supersets thereof) can be performed in a different order.

Management program 214 automatically sends (902) a plurality of requests for content to a plurality of client devices 104 associated with the user. The requests for content are determined in accordance with storage server profile 216. In some embodiments, the plurality of client devices include a plurality of different types of devices, such as digital video recorders, digital video cameras, digital still cameras, and digital music players. In some embodiments, the digital video recorders are TiVo digital video recorders and/or Windows Media Center-compatible digital video recorders. In some embodiments, at least one of the plurality of client devices (e.g., 104-x) is in an external network 112 outside of LAN 106. In some embodiments, all of the plurality of client devices 104 are in LAN 106. In some embodiments, LAN 106 is a home network.

In some embodiments, the storage server profile of the user includes rules 304 and/or 306 specifying content 416 from one or more client devices 104 to be transferred and stored in the storage server 102. In some embodiments, the rules include global rules (e.g., transfer and store all content from all clients), client-specific rules (e.g. transfer and store from client x content that satisfies condition y), and/or transfer scheduling rules. In some embodiments, client content 416 has metadata (e.g., metatags) or has an associated file of content information that includes such metadata. The metadata may be used to select content 416 for transfer and storage. In some embodiments, the storage server profile 216 is configured by the user (e.g., using remote control 118). In some embodiments, the storage server profile is automatically configured without user intervention.

In some embodiments, at least some content 416 in at least some of the client devices is acquired by the corresponding client 104 in accordance with client content acquisition rules 320 in the storage server profile 216. In these embodiments, in addition to managing the transfer and storage of content from client devices 104, storage server 102 also manages the initial acquisition of content on at least some of the client devices 104 (e.g., using content acquisition techniques analogous to those described in U.S. Pat. Nos. 6,642,939 and 6,757,906 and U.S. patent application Ser. Nos. 10/339,699 and 10/034,679, which are all incorporated by reference herein in their entirety).

In response to at least one of the requests for content, storage server 102 receives (904) content from at least one of the plurality of client devices 104. Receiving content frees up storage space on the client devices from which content was received. In some embodiments, the received content is protected by digital rights management technique(s) (e.g., via encryption). In other embodiments, the received content is not protected by digital rights management technique(s). In some embodiments, some of the received content is protected (e.g., video content from a TiVo digital video recorder) and some of the received content is not protected by digital rights management technique(s) (e.g., video content from a Windows Media Center-compatible digital video recorder, or video, image, and/or audio content created by the user). In some embodiments, storage server 102 can receive, store, and serve both protected and unprotected content.

In some embodiments, content on the client 104 that corresponds to the content stored by storage server 102 is marked as available for deletion, deleted, or otherwise made available for reuse to free up storage space on the client 104.

Storage server 102 stores (906) at least some of the received content. In some embodiments, the stored received content is selected from the received content in accordance with the storage server profile. In some embodiments, the freed up storage space on the client devices corresponds to the content that is received and stored on the storage server. In some embodiments, the stored received content is stored in a RAID 5 array of storage devices. In some embodiments, the storage devices are automatically reviewed for consistency, and inconsistencies in the stored content and its computed parity are found and repaired (“disk scrubbing”).

Management program 214 updates (908) the index 232 of content files on the storage server to include the stored received content. In some embodiments, the index 232 is a hierarchical data structure. In some embodiments, the user is notified that new content has been added to storage server 102, e.g., by displaying a message in a GUI 108 on a client 104 and/or by sending an e-mail, text message, or other electronic message to the user.

Management program 214 receives (910) a request for a content file in the index 232 to be served to a client device 104 in the plurality of client devices. In some embodiments, the request for the content file is made in response to the user selecting a menu item with a remote control 118.

In response to the request for the content file, file server 234 serves (912) the requested content file to the client device 104. The requested content file may be one or more files in video files 224, image files 226, audio files 228, or complementary content 230. In some embodiments, serving includes streaming the requested content file to the client device 104. In some embodiments, serving includes sending the requested content file to the client device 104 for download and storage. In some embodiments, the client device 104 to which the requested content file is served is in the LAN 106 of the user. In some embodiments, the client device (e.g. 104-x) to which the requested content file is served is in an external network 112 outside of the LAN 106 of the user.

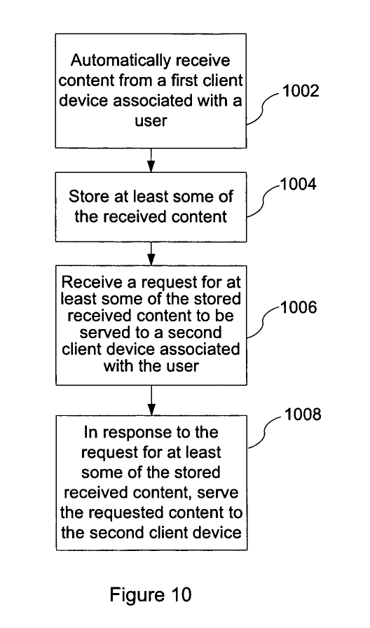

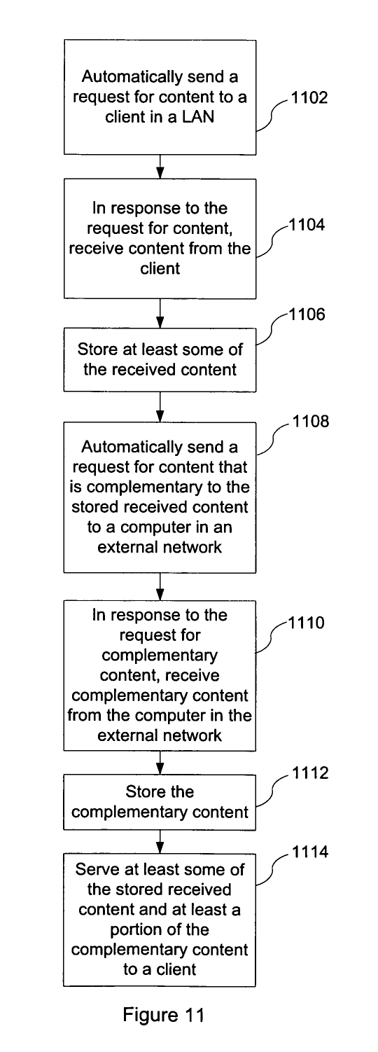

FIG. 10 is a flowchart representing a method of performing automatic storage and serving functions in accordance with embodiments of the present invention. The processes shown in FIG. 10 (or subsets or supersets thereof) are performed by storage server 102 (FIG. 1). It will be appreciated by those of ordinary skill in the art that one or more of the acts described may be performed by hardware, software, or a combination thereof. In addition, it will be appreciated by those of ordinary skill in the art that some of the processes shown in FIG. 10 (or subsets or supersets thereof) can be performed in a different order.

Storage server 102 automatically receives (1002) content from a first client device (e.g., 104-1) associated with the user. The client device may be associated with the user in a variety of ways, such as by being in the user's LAN 106 or by having its client ID 302 included in server storage profile 216 based on input by the user. In some embodiments, the storage server profile 216 is just for clients 104 in the LAN of the user. The received content is determined in accordance with storage server profile 216 for storage server 102. Receiving the content frees up storage space on the first client device.

In some embodiments, the content is received from the first client device in response to a request for content by the server, wherein the request for content is determined in accordance with the storage server profile 216.

In some embodiments, the received content includes digital video, digital images, and/or digital audio. In some embodiments, the received content is encrypted. In some embodiments, the received content includes digital copies of video, images, and/or audio stored on the first client device. In some embodiments, the received content includes digital copies of video, images, and/or audio that was streamed over the first client device (e.g., if the first client device does not have any nonvolatile storage, it may just stream the content that it receives to the storage server).

In some embodiments, at least some content 416 in the first client device is acquired by the first client device in accordance with client content acquisition rules 320 in the storage server profile 216. In these embodiments, in addition to managing the transfer and storage of content from client devices 104, storage server 102 also manages the initial acquisition of content on at least some of the client devices 104 (e.g., using content acquisition techniques analogous to those described in U.S. Pat. Nos. 6,642,939 and 6,757,906 U.S. patent application Ser. Nos. 10/339,699 and 10/034,679, which are all incorporated by reference herein in their entirety).

In some embodiments, the first client device (e.g., 104-x) is in an external network 112 outside of the LAN 106 of the user. In some embodiments, the first client device (e.g., 104-1) is in the LAN 106 of the user. In some embodiments, the first client device is in the LAN via a wireless or wireline connection. In some embodiments, the LAN of the user is a home network. In some embodiments, the first client device is a digital video recorder, digital video camera, digital still camera, Internet radio, digital music player, digital media adapter, personal digital assistant, cell phone, gaming console, handheld gaming device, desktop computer, laptop computer, handheld computer or a combination thereof.

In some embodiments, the first and second client devices are digital video recorders. In some embodiments, the digital video recorders are TiVo digital video recorders. In some embodiments, the digital video recorders are Windows Media Center-compatible digital video recorders.

In some embodiments, the storage server profile of the user includes rules 304 and/or 306 specifying content from one or more client devices 104 to be transferred and stored in the storage server 102. In some embodiments, the rules include global rules, client-specific rules, and/or transfer scheduling rules. In some embodiments, the storage server profile 216 is configured by the user. In some embodiments, client content 416 has metadata (e.g., metatags) or has an associated file of content information that includes such metadata. The metadata may be used to select content 416 for transfer and storage. In some embodiments, the storage server profile is configured by the user with a remote control 118. In some embodiments, the storage server profile is automatically configured without user intervention.

Storage server 102 stores (1004) at least some of the received content. In some embodiments, the stored received content is selected from the received content in accordance with the storage server profile 216. In some embodiments, the freed up storage space on the first client device corresponds to the content that is received and stored on the storage server. In some embodiments, the stored received content is stored in a RAID 5 array of storage devices with disk scrubbing.

In some embodiments, management program 214 updates an index 232 of content files on the storage server to include the stored received content. In some embodiments, the index 232 is a hierarchical data structure. In some embodiments, the user is notified that new content has been added to storage server 102, e.g., by displaying a message in a GUI 108 on a client 104 and/or by sending an e-mail, text message, or other electronic message to the user.

Content on the client 104 that corresponds to the content stored by storage server 102 is marked as available for deletion, deleted, or otherwise made available for reuse to free up storage space on the client 104.

Management program 214 receives (1006) a request for at least some of the stored received content to be served to a second client device (e.g., 104-2) associated with the user. In some embodiments, the second client device is in the LAN 106 of the user. In some embodiments, the second client device is in an external network 112 outside of the LAN 106 of the user. In some embodiments, the request for the stored received content is made in response to the user selecting a menu item with a remote control 118. In some embodiments, the request for the stored received content is made in response to the user selecting an item in a hierarchical menu with a remote control 118.

In response to the request for at least some of the stored received content, file server 234 serves (1008) the requested content to the second client device. In some embodiments, serving includes streaming the requested content to the second client device. In some embodiments, serving includes sending the requested content to the second client device for download and storage. In some embodiments, the second client device is also the first client device. In some embodiments, the second client device is not the first client device.

FIG. 11 is a flowchart representing a method of performing automatic library creation in accordance with embodiments of the present invention. The processes shown in FIG. 11 (or subsets or supersets thereof) are performed by storage server 102 in LAN 106 (FIG. 1). It will be appreciated by those of ordinary skill in the art that one or more of the acts described may be performed by hardware, software, or a combination thereof. In addition, it will be appreciated by those of ordinary skill in the art that some of the processes shown in FIG. 11 (or subsets or supersets thereof) can be performed in a different order.

Management program 214 automatically sends (1102) a request for content to a first client in LAN 106. The request for content is determined in accordance with one or more content transfer/storage rules 304 and/or 306 in a storage server profile 216. In some embodiments, LAN 106 is a home network.

In response to the request for content, storage server 102 receives (1104) content from the first client. Receiving content frees up storage space on the first client. In some embodiments, the first client is a digital video recorder (e.g., a TiVo digital video recorder or a Window Media Center-compatible digital video recorder).

In some embodiments, at least some content 416 is acquired by the first client 104 in accordance with client content acquisition rules 320 in the storage server profile 216. In these embodiments, in addition to managing the transfer and storage of content from client devices 104, storage server 102 also manages the initial acquisition of content on at least one of the client devices 104 (e.g., using content acquisition techniques analogous to those described in U.S. Pat. Nos. 6,642,939 and 6,757,906 and U.S. patent application Ser. Nos. 10/339,699 and 10/034,679, which are all incorporated by reference herein in their entirety).

Storage server 102 stores (1106) at least some of the received content. In some embodiments, the stored received content is selected from the received content in accordance with the storage server profile 216. In some embodiments, the freed up storage space on the first client corresponds to the content that is received and stored on the storage server. In some embodiments, management program 214 updates the index 232 of content files on the storage server to include the received content. In some embodiments, the index 232 is a hierarchical data structure. In some embodiments, content on the client 104 that corresponds to the content received by storage server 102 is marked as available for deletion, deleted, or otherwise made available for reuse to free up storage space on the client 104.

Management program 214 automatically sends (1108) a request for content that is complementary to the stored received content (i.e., “complementary content”) to a computer in an external network 112. The request for complementary content is determined in accordance with complementary content acquisition rules 308 in the storage server profile 216.

In response to the request for complementary content, storage server 102 receives (1110) complementary content 230 from the computer in the external network 112. In some embodiments, the complementary content 230 from the computer in the external network includes web sites, web pages or other search results from a search engine 120, content offered in an RSS feed or portion thereof from an RSS server 122, a review of the stored received content from a review/rating server 124, and/or content from a peer-to-peer computer 126.

Storage server 102 stores (1112) the complementary content 230. In some embodiments, the stored content received from the first client device and the complementary content 230 is stored in a RAID 5 array with disk scrubbing. In some embodiments, the user is notified that new content from the first client device and/or complementary content has been added to storage server 102, e.g., by displaying a message in a GUI 108 on a client 104 and/or by sending an e-mail, text message, or other electronic message to the user.

File server 234 serves (1114) at least some of the stored received content (e.g., 224, 226, or 228) and at least a portion of the complementary content 230 to a second client 104. In some embodiments, the second client is in the LAN 106. In some embodiments, the second client (e.g., 104-x) is in an external network 112 outside of the LAN 106 of the user. In some embodiments, the second client device is a digital video recorder, digital media adapter, digital music player, Internet radio, personal digital assistant, cell phone, gaming console, handheld gaming device, desktop computer, laptop computer, handheld computer, or a combination thereof. In some embodiments, content is served in response to management program 214 receiving a request for content 222 in the index 232 from a client device 104. In some embodiments, the request for content 222 is made in response to the user selecting a menu item in GUIs like those shown in FIGS. 8A-8C with a remote control 118. In some embodiments, the second client device is not the first client device. In some embodiments, the second client device is also the first client device.

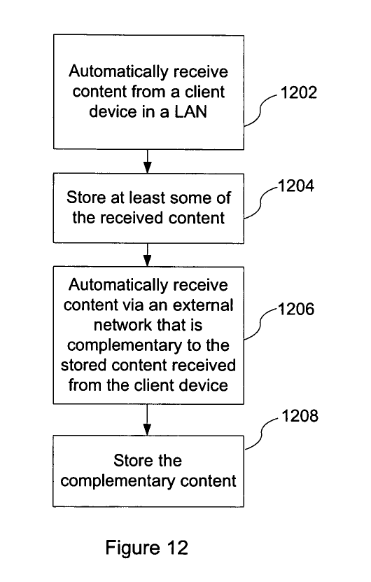

FIG. 12 is a flowchart representing a method of performing automatic library creation in accordance with embodiments of the present invention. The processes shown in FIG. 12 (or subsets or supersets thereof) are performed by storage server 102 in LAN 106 (FIG. 1). It will be appreciated by those of ordinary skill in the art that one or more of the acts described may be performed by hardware, software, or a combination thereof. In addition, it will be appreciated by those of ordinary skill in the art that some of the processes shown in FIG. 12 (or subsets or supersets thereof) can be performed in a different order.

Storage server 102 automatically receives (1202) content from a client device 104 in the LAN 106. The received content is determined in accordance with a storage server profile 216. Receiving content frees up storage space on the client device. In some embodiments, the content is received from the client device 104 in response to a request for content by storage server 102, wherein the request for content is determined in accordance with the storage server profile 216. In some embodiments, the LAN is a home network.

In some embodiments, the received content includes digital video, digital images, and/or digital audio. In some embodiments, the received content is encrypted. In some embodiments, the received content includes digital copies of video, images, and/or audio stored on the client device. In some embodiments, the received content includes digital copies of video, images, and/or audio that was streamed over the client device.

In some embodiments, at least some content 416 is acquired by the client device 104 in accordance with client content acquisition rules 320 in the storage server profile 216. In these embodiments, in addition to managing the transfer and storage of content from client devices 104, storage server 102 also manages the initial acquisition of content on at least one of the client devices 104 (e.g., using content acquisition techniques analogous to those described in U.S. Pat. Nos. 6,642,939 and 6,757,906 and U.S. patent application Ser. Nos. 10/339,699 and 10/034,679, which are all incorporated by reference herein in their entirety).

In some embodiments, the content received from the client device 104 is a movie or television program and the complementary content 230 is a review, interview, article, or blog about the movie or television program or about people or events associated with the movie or television program.

In some embodiments, the client device 104 is in the LAN 106 via a wireless or wireline connection. In some embodiments, the client device 104 is a digital video recorder, digital video camera, digital still camera, Internet radio, digital music player, digital media adapter, personal digital assistant, cell phone, gaming console, handheld gaming device, desktop computer, laptop computer, handheld computer or a combination thereof.

In some embodiments, the client device 104 is a digital video recorder (e.g., a TiVo digital video recorder or a Window Media Center digital video recorder).

In some embodiments, the storage server profile 216 includes rules 304 and/or 306 specifying content from one or more client devices 104 to be transferred and stored in the storage server 102 and rules specifying content 230 that is complementary to the content from the one or more client devices that is to be acquired from computers in an external network 112. In some embodiments, the rules specifying content from one or more client devices include global rules, client-specific rules, and/or transfer scheduling rules. In some embodiments, client content 416 and complementary content have metadata (e.g., metatags) or have an associated file of content information that includes such metadata. The metadata may be used to select client content for transfer and storage and complementary content for acquisition. In some embodiments, the storage server profile 216 is configured by the user. In some embodiments, the storage server profile 216 is automatically configured without user intervention.

Storage server 102 stores (1204) at least some of the content received from the client device. In some embodiments, the stored content received from the client device is selected from the content received from the client device in accordance with the storage server profile 216. In some embodiments, the freed up storage space on the client device corresponds to the content that is received and stored on the storage server. Content on the client 104 that corresponds to the content stored by storage server 102 is marked as available for deletion, deleted, or otherwise made available for reuse to free up storage space on the client 104.

Storage server 102 automatically receives (1206) content via an external network 112 that is complementary to the stored content received from the client device 104. The complementary content 230 is determined in accordance with the storage server profile 216. In some embodiments, the complementary content 230 is an RSS feed or portion thereof that relates to the stored content received from the client device. In some embodiments, the complementary content 230 from the computer in the external network includes web sites, web pages or other search results from a search engine 120, an RSS feed or portion thereof from an RSS server 122, a review of the stored received content from a review server 124, and/or content from a peer-to-peer computer 126.

Storage server 102 stores (1204) the complementary content 230. In some embodiments, the stored content received from the client device and the complementary content 230 is stored in a RAID 5 array with disk scrubbing. In some embodiments, management program 214 updates an index 232 of content files on the storage server 102 to include the stored content received from the client device and the complementary content 230. In some embodiments, the index 232 is a hierarchical data structure. In some embodiments, the user is notified that new content from the client device and/or complementary content has been added to storage server 102, e.g., by displaying a message in a GUI 108 on a client 104 and/or by sending an e-mail, text message, or other electronic message to the user.

In some embodiments, file server 234 serves at least some of the stored content received from the client device and at least some of the complementary content 230 to a second client device 104. In some embodiments, serving includes streaming at least some of the stored content received from the client device and at least some of the complementary content 230 to the second client device. In some embodiments, serving includes sending at least some of the stored content received from the client device and at least some of the complementary content 230 to the second client device for download and storage. In some embodiments, the serving is done in response to the user selecting a menu item with a remote control. In some embodiments, the serving is done in response to the user selecting an item in a hierarchical menu with a remote control. In some embodiments, the second client device is not the client device from which content was received. In some embodiments, the second client device is also the client device from which content was received. In some embodiments, the second client is in the LAN 106. In some embodiments, the second client (e.g., 104-x) is in an external network 112 outside of the LAN 106 of the user.

The foregoing description, for purpose of explanation, has been described with reference to specific embodiments. However, the illustrative discussions above are not intended to be exhaustive or to limit the invention to the precise forms disclosed. For example, although storage devices have typically been described as disk storage devices, a person of ordinary skill in the art would understand that one or more of the storage devices may also be other forms of nonvolatile storage, such as a flash memory that mimics the operation of a disk storage device. Similarly, although the embodiments are well-suited to a home network, other types of LANs may also be used (e.g., LANs in a small business, corporate, or educational setting). Many modifications and variations are possible in view of the teachings above. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising: at a storage server in a local area network of a user,
automatically sending a request for content to a first client in the local area network, wherein the request for content is determined in accordance with one or more content transfer rules in a storage server profile for the storage server;
in response to the request for content, receiving content from the first client, wherein receiving content frees up storage space on the first client;
storing at least some of the received content;
automatically sending a request for content that is complementary to the stored received content to a computer in an external network, wherein the request for complementary content is determined in accordance with complementary content acquisition rules in the storage server profile;
in response to the request for complementary content, receiving complementary content from the computer in the external network;
storing the complementary content; and
serving at least some of the stored received content and at least a portion of the complementary content to a second client.

2. The method of claim 1, wherein the stored received content is selected from the received content in accordance with the storage server profile.

3. The method of claim 1, wherein the freed up storage space on the first client corresponds to the content that is received and stored on the storage server.

4. The method of claim 1, wherein the first client is a digital video recorder.

5. The method of claim 4, wherein the digital video recorder is a TiVo digital video recorder.

6. The method of claim 4, wherein the digital video recorder is a Window Media Center compatible digital video recorder.

7. The method of claim 1, wherein the second client is a digital video recorder, digital media adapter, desktop computer, laptop computer, or handheld computer.

8. The method of claim 1, wherein the complementary content from the computer in the external network includes search results from a search engine, an RSS feed or portion thereof from an RSS server, a review of the stored received content from a review server, or content from a peer-to-peer computer.

9. The method of claim 1, wherein the stored content received from the first client and the complementary content is stored in a RAID 5 array with disk scrubbing.

10. The method of claim 1, wherein the local area network is a home network.

11. The method of claim 1, wherein the second client is not the first client.

12. The method of claim 1, wherein the second client is also the first client.

13. The method of claim 1, wherein the second client is in the local area network.

14. The method of claim 1, wherein the second client is in an external network outside of the local area network of the user.

15. A storage server in a local area network of a user, comprising:
one or more processors;
memory; and
a program, wherein the program is stored in the memory and configured to be executed by the one or more processors, the program including:
instructions for automatically sending a request for content to a first client in the local area network, wherein the request for content is determined in accordance with one or more content transfer rules in a storage server profile for the storage server;
instructions for, in response to the request for content, receiving content from the first client, wherein receiving content frees up storage space on the first client;
instructions for storing at least some of the received content;
instructions for automatically sending a request for content that is complementary to the stored received content to a computer in an external network, wherein the request for complementary content is determined in accordance with complementary content acquisition rules in the storage server profile;
instructions for, in response to the request for complementary content, receiving complementary content from the computer in the external network;
instructions for storing the complementary content; and
instructions for serving at least some of the stored received content and at least a portion of the complementary content to a second client.

16. A computer-program product, comprising:
a computer readable storage medium and a computer program mechanism embedded therein, the computer program mechanism comprising instructions, which when executed by a storage server in a local area network of a user, cause the storage server to:
automatically send a request for content to a first client in the local area network, wherein the request for content is determined in accordance with one or more content transfer rules in a storage server profile for the storage server;
in response to the request for content, receive content from the first client, wherein receiving content frees up storage space on the first client;
store at least some of the received content;
automatically send a request for content that is complementary to the stored received content to a computer in an external network, wherein the request for complementary content is determined in accordance with complementary content acquisition rules in the storage server profile;
in response to the request for complementary content, receive complementary content from the computer in the external network;
store the complementary content; and
serve at least some of the stored received content and at least a portion of the complementary content to a second client.

17. A storage server in a local area network of a user, comprising:
means for automatically sending a request for content to a first client in the local area network, wherein the request for content is determined in accordance with one or more content transfer rules in a storage server profile for the storage server;
means for in response to the request for content, receiving content from the first client, wherein receiving content frees up storage space on the first client;
means for storing at least some of the received content;
means for automatically sending a request for content that is complementary to the stored received content to a computer in an external network, wherein the request for complementary content is determined in accordance with complementary content acquisition rules in the storage server profile;
in response to the request for complementary content, means for receiving complementary content from the computer in the external network;
means for storing the complementary content; and
means for serving at least some of the stored received content and at least a portion of the complementary content to a second client.

18. A computer-implemented method, comprising: at a storage server in a local area network of a user,
automatically receiving content from a client device in the local area network, wherein:
the received content is determined in accordance with a storage server profile for the storage server, and
receiving content frees up storage space on the client device;
storing at least some of the content received from the client device;
automatically receiving content via an external network that is complementary to the stored content received from the client device, wherein the complementary content is determined in accordance with the storage server profile; and
storing the complementary content.

19. The method of claim 18, wherein the stored content received from the client device is selected from the content received from the client device in accordance with the storage server profile.

20. The method of claim 18, wherein the freed up storage space on the client device corresponds to the content that is received and stored on the storage server.

21. The method of claim 18, wherein the content received from the client device is a movie or television program and the complementary content is a review, interview, article, or blog about the movie or television program or about people or events associated with the movie or television program.

22. The method of claim 18, wherein the complementary content is an RSS feed or portion thereof that relates to the content received from the client device.

23. The method of claim 18, wherein the content is received from the client device in response to a request for content by the storage server,

24. The method of claim 18, wherein the request for content is determined in accordance with the storage server profile.

25. The method of claim 18, wherein the content received from the client device includes digital video, digital images, and/or digital audio.

26. The method of claim 18, wherein the content received from the client device is encrypted.

27. The method of claim 18, wherein the content received from the client device includes digital copies of video, images, and/or audio stored on the client device.

28. The method of claim 18, wherein the client device is in the local area network via a wireless or wireline connection.

29. The method of claim 18, wherein the client device is a digital video recorder, digital video camera, digital still camera, Internet radio, digital music player, digital media adapter, personal digital assistant, cell phone, gaming console, handheld gaming device, desktop computer, laptop computer, handheld computer or a combination thereof.

30. The method of claim 18, wherein the client device is a digital video recorder.

31. The method of claim 30, wherein the digital video recorder is a TiVo digital video recorder.

32. The method of claim 30, wherein the digital video recorder is a Windows Media Center-compatible digital video recorder.

33. The method of claim 18, wherein the storage server profile of the user includes rules specifying content from one or more client devices to be stored in the storage server and rules specifying content that is complementary to the content from the one or more client devices that is to be acquired from computers in an external network.

34. The method of claim 33, wherein the rules specifying content from one or more client devices include global rules, client-specific rules, and/or transfer scheduling rules.

35. The method of claim 18, wherein the storage server profile is configured by the user.

36. The method of claim 18, wherein the storage server profile is automatically configured without user intervention.

37. The method of claim 18, further comprising updating an index of content files on the storage server to include the stored content received from the client device and the complementary content.

38. The method of claim 37, wherein the index is a hierarchical data structure.

39. The method of claim 18, further comprising serving at least some of the stored content received from the client device and at least some of the complementary content to a second client device.

40. The method of claim 39, wherein serving includes streaming at least some of the stored content received from the client device and at least some of the complementary content 230 to the second client device.

41. The method of claim 39, wherein serving includes sending at least some of the stored content received from the client device and at least some of the complementary content 230 to the second client device for download and storage.

42. The method of claim 39, wherein the serving is done in response to the user selecting a menu item with a remote control.

43. The method of claim 39, wherein the serving is done in response to the user selecting an item in a hierarchical menu with a remote control.

44. The method of claim 18, wherein the stored content received from the client device and the complementary content is stored in a RAID 5 array with disk scrubbing.

45. The method of claim 39, wherein the second client device is not the client device from which content was received.

46. The method of claim 39, wherein the second client device is also the client device from which content was received.

47. The method of claim 18, wherein the local area network is a home network.

48. The method of claim 39, wherein the second client is in the local area network.

49. The method of claim 39, wherein the second client is in an external network outside of the local area network of the user.

50. A storage server in a local area network of a user, comprising:
one or more processors;
memory; and
a program, wherein the program is stored in the memory and configured to be executed by the one or more processors, the program including:
instructions for automatically receiving content from a client device in the local area network, wherein:
the received content is determined in accordance with a storage server profile for the storage server, and
receiving content frees up storage space on the client device;
instructions for storing at least some of the content received from the client device;
instructions for automatically receiving content via an external network that is complementary to the stored content received from the client device, wherein the complementary content is determined in accordance with the storage server profile; and
instructions for storing the complementary content.

51. A computer-program product, comprising:
a computer readable storage medium and a computer program mechanism embedded therein, the computer program mechanism comprising instructions, which when executed by a storage server in a local area network of a user, cause the storage server to:
automatically receive content from a client device in the local area network, wherein:
the received content is determined in accordance with a storage server profile for the storage server, and
receiving content frees up storage space on the client device;
store at least some of the content received from the client device;
automatically receive content via an external network that is complementary to the stored content received from the client device, wherein the complementary content is determined in accordance with the storage server profile; and
store the complementary content.

52. A storage server in a local area network of a user, comprising:
means for automatically receiving content from a client device in the local area network, wherein:
the received content is determined in accordance with a storage server profile for the storage server, and
receiving content frees up storage space on the client device;
means for storing at least some of the content received from the client device;
means for automatically receiving content via an external network that is complementary to the stored content received from the client device, wherein the complementary content is determined in accordance with the storage server profile; and
means for storing the complementary content.
